(19) United States
(12) Patent Application Publication
(10) Pub. No.: US 2005/0207066 A1
(43) Pub. Date: Sep. 22, 2005

(54) Recording disk drive and ramp member therefor

(75) Inventors: Hiroaki Kobayashi, Kawasaki (JP); Kazunori Akama, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/128,377

(22) Filed: May 13, 2005

Related U.S. Application Data
(63) Continuation of application No. PCT/JP03/07788, filed on Jun. 19, 2003.

(51) Int. Cl. G11B 5/54

(52) U.S. Cl. 360/255

(57) ABSTRACT

A recording disk drive includes a restriction member located within an enclosure at a location opposed to a slant. The slant is defined on a ramp member so as to get closer to a recording disk at a location closer to the center of the recording disk. The slant is designed to receive the tip end of a head actuator supporting a head slider. If an impact acts on the recording disk drive during the movement of the head slider toward the recording disk or off the recording disk, the tip end of the head actuator tends to jump up from the slant. Here, the tip end of the head actuator is received on the restriction member. The restriction member thus serves to reliably prevent the head slider from jumping up. The head slider is prevented from colliding against the enclosure.

### BACKGROUND OF THE INVENTION

1. Field of the Invention

The present invention relates to a recording disk drive such as a hard disk drive, for example. In particular, the invention relates to a ramp member including; an attachment base standing on the enclosure of the recording disk drive in the vertical direction; and a protrusion extending in the horizontal direction from the surface of the attachment base and defining a slant getting closer to the a recording disk at a location closer to the center of the recording disk.

2. Description of the Prior Art

A load/unload mechanism is well known in the technical field of hard disk drives, for example. The load/unload mechanism allows a flying head slider to stay at an inoperative position outside the outer periphery of a magnetic recording disk when the magnetic recording disk stands still. A load tab extending from the tip end of the head suspension is received on a ramp member.

The load tab slides on the ramp member when the flying head slider moves toward the magnetic recording disk or when the flying head slider moves outward toward the inoperative position. When an impact acts on the hard disk drive during the movement of the flying head slider, the load tab jumps up from the ramp member. The flying head slider strikes hard the enclosure of the hard disk drive. The flying head slider sometimes suffers from damages.

### SUMMARY OF THE INVENTION

It is accordingly an object of the present invention to provide a recording disk drive capable of reliably preventing a head slider from jumping up when the head slider moves toward a recording disk or off the recording disk.

According to the present invention, there is provided a recording disk drive comprising: an enclosure; a recording disk enclosed in the enclosure; a head slider opposed to the surface of the recording disk; a head actuator supporting a head slider at the tip end of the head actuator; an attachment base standing on the enclosure in a vertical direction; a protrusion extending in a horizontal direction from the attachment base and defining a slant getting closer to the recording disk at a location closer to the center of the recording disk; and a restriction member located within the enclosure at a location opposed to the slant on the protrusion.

The tip end of the head actuator is contacted with the slant based on the rotation of the head actuator when the head slider moves off the recording disk. When the head actuator further swings, the tip end of the head actuator climbs up the slant. The head actuator thereafter allows the tip end to slide on the surface of the protrusion. The head slider can thus be brought to an inoperative position.

The tip end of the head actuator moves downward along the slant based on the rotation of the head actuator when the head slider moves toward the recording disk. The head slider gets opposed to the surface of the recording disk during the downward movement of the tip end of the head actuator. Airflow generates a lift on the head slider. The lift serves to keep the head slider flying above the surface of the recording disk.

The recording disk drive allows the restriction member to oppose an opposed surface to the slant. If an impact acts on the recording disk drive during the movement of the head slider toward the recording disk or off the recording disk, the tip end of the head actuator tends to jump up from the slant. Here, the tip end of the head actuator is received on the opposed surface of the restriction member. The restriction member thus serves to reliably prevent the head slider from jumping up. The head slider is prevented from colliding against the enclosure.

The recording disk drive may further comprise: a first sliding surface defined on the protrusion and extending in the horizontal direction from the highest end of the slant along the surface of the attachment base, said first sliding surface getting opposed to the restriction member; and a second sliding surface defined on the protrusion and extending downward from the first sliding surface along the surface of the attachment base. Here, the first sliding surface may be opposed to the restriction member. The second sliding surface may likewise be opposed to the restriction member.

The tip end of the head actuator moves to the first sliding surface from the slant when the head slider moves off the recording disk. When the head actuator further swings, the tip end of the head actuator moves to the second sliding surface from the first sliding surface. The tip end of the head actuator can be received on the opposed surface of the restriction member even when an impact acts on the recording disk drive. The restriction member thus serves to reliably prevent the head slider from jumping up.

In general, the attachment base and the protrusion form a ramp member. The restriction member may be integral to the attachment base and the protrusion based on integral molding. Otherwise, the restriction member may be fixed to the inward surface of the enclosure.

A specific ramp member may be provided to realize the aforementioned recording disk drive. The ramp member comprises: an attachment base standing in a vertical direction from a lower end received on an enclosure of the recording disk drive; a protrusion extending in a horizontal direction from the surface of the attachment base and defining a slant getting closer to the recording disk at a location closer to the center of a recording disk; and a restriction piece defining an opposed surface opposed to the slant on the protrusion.

The ramp member allows the restriction piece to oppose the opposed surface to the slant. If an impact acts on the recording disk drive during the movement of the head slider toward the recording disk or off the recording disk, the tip end of the head actuator is received on the opposed surface of the restriction piece. The restriction piece thus serves to reliably prevent the head slider from jumping up.

The ramp member may further comprise: a first sliding surface defined on the protrusion and extending in the horizontal direction from the highest end of the slant along the surface of the attachment base, said first sliding surface getting opposed to the restriction piece; and a second sliding surface defined on the protrusion and extending downward from the first sliding surface along the surface of the attachment base. The first sliding surface may be opposed to the restriction piece. The restriction piece may be coupled to the attachment base based on integral molding.

Another specific ramp member may be provided to realize the aforementioned recording disk drive. The ramp member comprises: an attachment base standing in a vertical direction from a lower end received on an enclosure of the recording disk drive; a protrusion extending in a horizontal direction from the surface of the attachment base and defining a slant getting closer to the recording disk at a location closer to the center of the recording disk; a first sliding surface defined on the protrusion and extending in the horizontal direction from the highest end of the slant along the surface of the attachment base; a second sliding surface defined on the protrusion and extending downward from the first sliding surface along the surface of the attachment base; and a restriction piece defining an opposed surface opposed to the first sliding surface. The restriction piece may be coupled to the attachment base based on integral molding.

A specific housing cover may be provided to realize the aforementioned recording disk drive. The housing cover may comprise: an inward surface extending along a datum plane and opposed to a head suspension supporting a head slider at the tip end; and a displacement restriction surface swelling from the inward surface and opposed to a ramp member designed to receive the tip end of the head suspension.

The housing cover may be utilized to form a recording disk drive. The displacement restriction surface is opposed to the tip end of the head suspension in the recording disk drive. If an impact acts on the recording disk drive during the movement of the head slider toward the recording disk or off the recording disk, the tip end of the head actuator is received on the displacement restriction surface. The displacement restriction surface thus serves to reliably prevent the head slider from jumping up.

The displacement restriction surface may be opposed to a slant defined on the ramp member so as to get closer to a recording disk at a location closer to the center of the recording disk. In addition, the displacement restriction surface may be opposed to a sliding surface defined on the ramp member continuously from the highest end of the slant, said sliding surface extending in a direction outward from the recording disk.

A specific housing base may likewise be provided to realize the aforementioned recording disk drive. The housing base may comprise: an inward surface extending along a datum plane and opposed to a head suspension supporting a head slider at the tip end; and a displacement restriction surface swelling from the inward surface. In this case, the displacement restriction surface may be opposed to a slant defined on a ramp member, said slant getting closer to a recording disk at a location closer to the center of the recording disk.

The housing base may be utilized to form a recording disk drive. The displacement restriction surface is opposed to the tip end of the head suspension in the recording disk drive. If an impact acts on the recording disk drive during the movement of the head slider toward the recording disk or off the recording disk, the tip end of the head actuator is received on the displacement restriction surface. The displacement restriction surface thus serves to reliably prevent the head slider from jumping up.

The displacement restriction surface may be opposed to a sliding surface defined on the ramp member continuously from the highest end of the slant. The sliding surface may extend in a direction outward from the recording disk.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the structure of a hard disk drive as an example of a recording disk drive according to an embodiment of the present invention;

FIG. 2 is an enlarged perspective view of a ramp member according to a specific example;

FIG. 3 is an enlarged partial sectional view taken along the line 3-3 in FIG. 1 for schematically illustrating the structure and functions of the ramp member;

FIG. 4 is an enlarged perspective view of a ramp member according to another example; and

FIG. 5 is an enlarged partial sectional view of the hard disk drive corresponding to FIG. 3.

### DESCRIPTION OF THE PREFERRED EMBODIMENTS

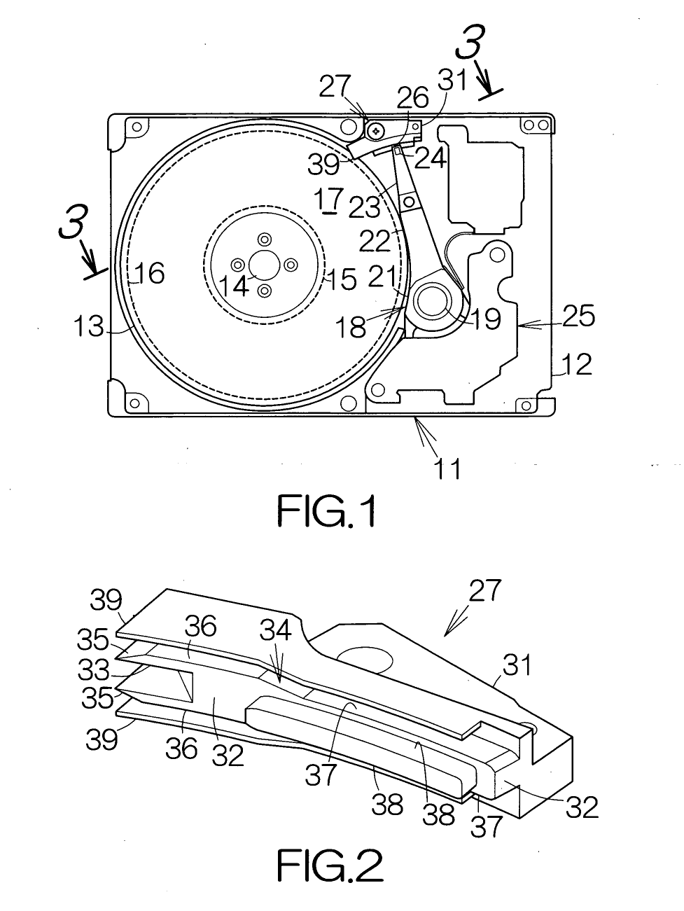

FIG. 1 schematically illustrates the inner structure of a hard disk drive (HDD) 11 as an example of a recording disk drive or storage device according to an embodiment of the present invention. The hard disk drive 11 includes a box-shaped main enclosure or housing base 12 defining an inner space of a flat parallelepiped, for example. A magnetic recording disk 13 as a recording medium is incorporated in the housing base 12. The magnetic recording disk 13 is mounted on the driving shaft of a spindle motor 14. The spindle motor 14 is allowed to drive the magnetic recording disk 13 for rotation at a higher revolution speed such as 5,400 rpm, 7,200 rpm, or the like, for example. A housing cover, not shown, is coupled to the housing base 12 so as to define the closed inner space between the housing base 12 and the housing cover itself.

A data zone 17 is defined over the front and back surfaces of the magnetic recording disk 13 between an innermost recording track 15 and an outermost recording track 16. Concentric recording circles or tracks are defined within the data zone 17. No magnetic information is recorded on a marginal zone or non-data zone inside the inner most recording track 15. Likewise, no magnetic information is recorded on a marginal zone or non-data zone outside the outermost recording track 16.

A head actuator 18 is also incorporated in the inner space of the housing base 12. The head actuator 18 includes an actuator block 21. The actuator block 21 is coupled to a vertical support shaft 19 for relative rotation. Rigid actuator arms 22 are defined in the actuator block 21 so as to extend in the horizontal direction from the vertical support shaft 19. The actuator block 21 may be made of aluminum. Molding process may be employed to form the actuator block 21.

Elastic head suspensions 23 are fixed to the corresponding tip ends of the actuator arms 22 so as to further extend in the forward direction from the actuator arms 22. A gimbal spring, not shown, is connected to the front end of the head suspension 23. A flying head slider 24 is received on the gimbal spring. The gimbal spring allows the flying head slider 24 to change the attitude relative to the head suspension 23.

An electromagnetic transducer, not shown, is mounted on the flying head slider 24. The electromagnetic transducer may include a write element and a read element. The write element may include a thin film magnetic head designed to write magnetic bit data into the magnetic recording disk 13 by utilizing a magnetic field induced at a thin film coil pattern. The read element may include a giant magnetoresistive (GMR) element or a tunnel-junction magnetoresistive (TMR) element designed to discriminate magnetic bit data on the magnetic recording disk 13 by utilizing variation in the electric resistance of a spin valve film or a tunnel-junction film, for example.

The head suspension 23 serves to urge the flying head slider 24 toward the surface of the magnetic recording disk 13. When the magnetic recording disk 13 rotates, the flying head slider 24 is allowed to receive airflow generated along the rotating magnetic recording disk 13. The airflow serves to generate a positive pressure or lift on the flying head slider 24. The flying head slider 24 is thus allowed to keep flying above the surface of the magnetic recording disk 13 during the rotation of the magnetic recording disk 13 at a higher stability established by the balance between the urging force of the elastic suspension 23 and the lift.

When the head actuator 18 is driven to swing about the vertical support shaft 19 during the flight of the flying head slider 24, the flying head slider 24 is allowed to move along the radial direction of the magnetic recording disk 13. This radial movement allows the electromagnetic transducer on the flying head slider 24 to cross the data zone 17 between the innermost recording track 15 and the outermost recording track 16. The flying head slider 24 can thus be positioned right above a target recording track on the magnetic recording disk 13. A power source 25 such as a voice coil motor (VCM) may be employed to realize the swinging movement of the head actuator 18, for example.

A load tab 26 is attached to the front or tip end of the head suspension 23 so as to further extend in the forward direction from the head suspension 23. The load tab 26 is allowed to move in the radial direction of the magnetic recording disk 13 based on the swinging movement of the head actuator 18. A ramp member 27 is located at a position outside the magnetic recording disk 13 on the movement path of the load tab 26. The ramp member 27 brings the tip end to a position inside the outer periphery of the magnetic recording disk 13, so that the tip end of the ramp member 27 is opposed to the non-data zone outside the outermost recording track 16. The combination of the load tab 26 and the ramp member 27 establishes a so-called load/unload mechanism. The ramp member 27 may be made of a hard plastic material, for example. Molding process may be employed to form the ramp member 27.

As shown in FIG. 2, the ramp member 27 includes an attachment base 31 fixed to the bottom plate of the housing base 12 outside the magnetic recording disk 13 based on a screw, for example. The attachment base 31 stands upright in the vertical direction from the lowest end received on the bottom plate of the housing base 12. The attachment base 31 defines a side wall surface standing upright from the bottom plate of the housing base 12. A protrusion 32 is formed on the sidewall surface of the attachment base 31. The protrusion 32 is designed to extend in the horizontal direction from the attachment base 31 toward the support shaft 19 of the head actuator 18. The protrusion 32 is coupled to the attachment base 31 based on integral molding, for example. A receiving groove 33 is defined in the attachment base 31 and the protrusion 32. The magnetic recording disk 13 is received inside the receiving groove 33.

Contact surfaces 34 are defined on the protrusion 32 along the movement path of the load tabs 26. The contact surface 34 includes a slant 35 at a location closest to the outermost recording track 16 on the magnetic recording disk 13. The slant 35 gets closer to the surface of the magnetic recording disk 13 at a location closer to the center of the magnetic recording disk 13. A first sliding surface 36 is connected to the highest or outer end of the slant 35. The first sliding surface 36 extends in the horizontal direction along the side wall surface of the attachment base 31. The first sliding surface 36 is defined along the movement path of the load tab 26. A second sliding surface 37 is connected to the outer end of the first sliding surface 36. The second sliding surface 37 extends outward in a direction getting remoter from the magnetic recording disk 13. The second sliding surface 37 extends downward from the first sliding surface 36 along the side wall surface of the attachment base 31. The second sliding surface 37 is defined along the movement path of the load tab 26. The second sliding surface 37 is concaved from the first sliding surface 36. In other words, the second sliding surface 37 gets closer to a horizontal plane including the surface of the magnetic recording disk 13 rather than the first sliding surface 36. An inclined surface is defined on the second sliding surface 37 so as to connect the second sliding surface 37 to the first sliding surface 36. The inclined surface extends downward at a location remoter from the first sliding surface 36.

A displacement receiving surface 38 is defined on the protrusion 32 at a position closer to the support shaft 19 than the contact surface 34. The displacement receiving surface 38 may extend in parallel with at least the second sliding surface 37. When the load tab 26 is received on the second sliding surface 37 as described later in detail, the displacement receiving surface 38 is opposed to the flying head slider 24. The displacement receiving surface 38 serves to avoid collision between the adjacent flying head sliders 24.

Plate-shaped restriction members or pieces 39 are formed on the side wall surface of the attachment base 31. The restriction pieces 39 extend in the horizontal direction toward the support shaft 19 of the head actuator 18. The slant 35 and the first and second sliding surfaces 36, 37 of the contact surface 34 are opposed to an opposed surface of the restriction piece 39. A predetermined space is defined between the restriction piece 39 and the contact surface 34 for receiving the load tab 26. An equal interval may be established between the restriction piece 39 and the first and second sliding surfaces 36, 37. The restriction piece 39 may be coupled to the attachment base 31 and the protrusion 32 based on integral molding.

Now, assume that the magnetic recording disk 13 stops rotating. When the write or read operation has been completed, the power source 25 drives the head actuator 18 around the support shaft 19 in a normal direction. The actuator arms 22 and the head suspensions 23 are moved outward to positions outside the magnetic recording disk 13. As shown in FIG. 3, when the flying head slider 24 gets opposed to the non-data zone or landing zone outside the outermost recording track 16, the load tab 26 contacts with the slant 35 of the contact surface 34. When the actuator arms 22 further swing, the load tabs 26 climb the corresponding slants 35. As the load tab 26 climbs up the slant 35 higher, the tip end of the head suspension 23 gets gradually distanced away from the surface of the magnetic recording disk 13. When the gimbal spring engages with the head suspension 23, the flying head slider 24 is pulled up from the surface of the magnetic recording disk 13. When the actuator arms 22 subsequently further swing, the load tabs 26 slide on the first and second sliding surfaces 36, 37. When the load tabs 26 reach positions remotest from the magnetic recording disk 13, the flying head sliders 24 are positioned at the inoperative positions. The load tabs 26 are in this manner received on the ramp member 27. The magnetic recording disk 13 subsequently stops rotating. Since the load tab 26 is held on the ramp member 27, the flying head slider 24 is prevented from contacting with or colliding against the magnetic recording disk 13 even without airflow. Adsorption can reliably be avoided between the flying head slider 24 and a lubricating agent spreading over the surface of the magnetic recording disk 13. In particular, since the load tab 26 is kept on the second sliding surface 37 of a lower level, the engagement of the flying head slider 24 is released in the head suspension 23. The gimbal spring can thus be prevented from deformation when the magnetic recording disk 13 stands still.

When the hard disk drive 11 receives the instructions for write or read operation, the magnetic recording disk 13 first starts rotating. When the rotation of the magnetic recording disk 13 has entered the steady state, the power source 25 drives the head actuator 18 around the support shaft 19 in the reverse direction opposite to the aforementioned normal direction. The actuator arms 22 and the head suspensions 23 are moved toward the center of the magnetic recording disk 13. The individual load tab 26 is forced to slide on the second and first sliding surfaces 37, 36 and the slant 35 in sequence. The load tab 26 moves downward along the slant 35 based on the swinging movement of the actuator arm 22.

The flying head slider 24 gets opposed to the surface of the magnetic recording disk 13 during the downward movement of the load tab 26 along the slant 35. The flying head slider 24 receives airflow generated along the surface of the rotating magnetic recording disk 13, so that a lift acts on the flying head slider 24. When the actuator arms 22 further swing, the load tabs 26 take off from the slant 35 or the ramp member 27. Since the magnetic recording disk 13 rotates in the steady state, the flying head sliders 24 keep flying above the surfaces of the magnetic recording disk 13 without a support of the ramp member 27.

The restriction piece 39 is allowed to oppose the opposed surface to the slant 35 and the first and second sliding surfaces 36, 37 in the hard disk drive 11. If an impact acts on the hard disk drive 11 during the movement of the flying head slider 24 toward the magnetic recording disk 13 or off the magnetic recording disk 13, the load tab 26 tends to jump up from the slant 35 as well as the first and second sliding surfaces 36, 37. Here, the load tab 26 can be received on the opposed surface of the restriction piece 39. The restriction piece 39 thus serves to reliably prevent the load tab 26 and the flying head slider 24 from jumping up. The flying head slider 24 is prevented from colliding against the housing base 12 or the housing cover. The flying head slider 24 can be protected from damages not only when the load tab 26 stands still but also when the load tab 26 is moving.

In particular, when one single magnetic recording disk 13 is incorporated within the hard disk drive 11 as described above, the magnetic recording disk 13 is in general located closer to the bottom plate of the housing base 12. A larger space is thus established between the housing cover and the slant 35 as well as between the housing cover and the first and second sliding surfaces 36, 37. Accordingly, if the flying head slider 24 collides against the housing cover across the larger space when the load tab 26 jumps up from the ramp member 27, an impact of an increased intensity acts on the housing cover. The restriction piece 39 serves to prevent the load tab 26 from jumping up from the ramp member 27 even in this case. The flying head slider 26 is reliably prevented from suffering from damages due to collision.

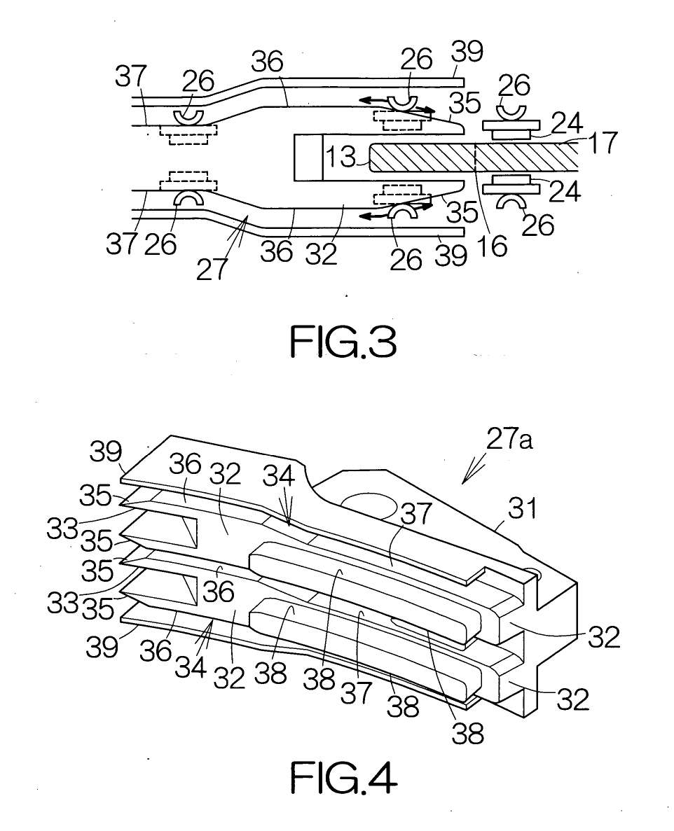

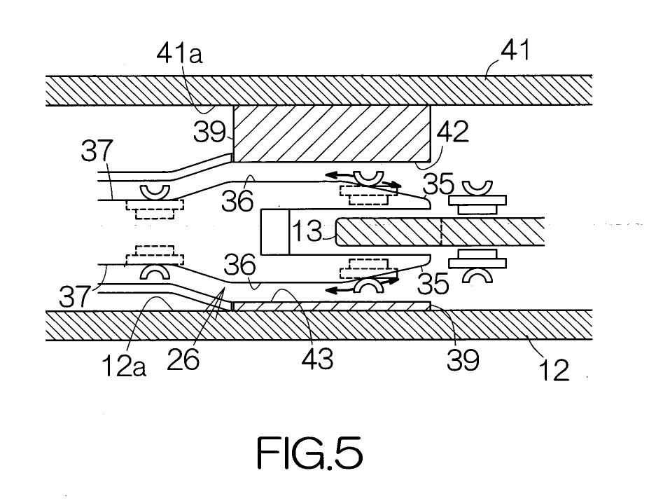

Two or more of the magnetic recording disk 13 may be incorporated within the hard disk drive 11, for example. In this case, the protrusions 32 may be formed on the ramp member 27a for the respective magnetic recording disks 13, as shown in FIG. 4. The receiving groove 33 is defined in the individual protrusion 32. The contact surface 34, including the slant 35 and the first and second sliding surfaces 36, 37, is defined on the individual protrusions 32 in the aforementioned manner. Like reference numerals are attached to structure or components equivalent to those of the aforementioned embodiment.

The hard disk drive 11 allows the restriction piece 39 to oppose the opposed surface to the slant 35 and the first and second sliding surface 36, 37. The load tab 26 is received on the opposed surface of the restriction piece 39 if an impact acts on the hard disk drive 11 during the movement of the flying head slider 24 toward the magnetic recording disk 13 or off the magnetic recording disk 13. The restriction piece 39 thus serves to reliably prevent the load tab 26 and the flying head slider 24 from jumping up. The flying head slider 24 is prevented from colliding against the housing base 12 or the housing cover. The flying head slider 24 can reliably be prevented from suffering from damages due to collision.

Otherwise, the restriction piece 39 may be coupled to the inward surface 41a of the housing cover 41, for example, as shown in FIG. 5. The inward surface 41a extends along a datum plane. The head suspension 23 is opposed to the inward surface 41a. A displacement restriction surface 42 is defined on the restriction piece 39. The displacement restriction surface 42 is opposed to the ramp member 27. The displacement restriction surface 42 swells from the inward surface 41a. Here, the slant 35 and the first sliding surface 36 are opposed to the displacement restriction surface 42. The second sliding surface 37 may additionally be opposed to the displacement restriction surface 42. Like reference numerals are attached to structure or components equivalent to those of the aforementioned embodiments.

The restriction piece 39 may likewise be coupled to the inward surface 12a of the housing base 12, for example. The inward surface 12a extends along a datum plane. The head suspension 23 is opposed to the inward surface 12a. A displacement restriction surface 43 is defined on the restriction piece 39. The displacement restriction surface 43 is opposed to the ramp member 27. The displacement restriction surface 43 swells from the inward surface 12a. Here, the slant 35 and the first sliding surface 36 are opposed to the displacement restriction surface 43. The second sliding surface 37 may additionally be opposed to the displacement restriction surface 43.

The displacement restriction surfaces 42, 43 are opposed to the slant 35 and the first sliding surface 36 in the hard disk drive 11. The load tab 26 is received on the displacement restriction surfaces 42, 43 if an impact acts on the hard disk drive 11 during the movement of the flying head slider 24 toward the magnetic recording disk 13 or off the magnetic recording disk 13. The displacement restriction surfaces 42, 43 thus serve to reliably prevent the load tab 26 and the flying head slider 24 from jumping up. The flying head slider 24 is prevented from colliding against the housing base 12 or the housing cover. The flying head slider 24 can reliably be prevented from suffering from damages due to collision.

It should be noted that the inward surface 41a of the housing cover 41 and the inward surface 12a of the housing base 12 may be utilized to for the displacement restriction surfaces 42, 43, respectively.

1. A recording disk drive comprising:
an enclosure;
a recording disk enclosed in the enclosure;
a head slider opposed to a surface of the recording disk;
a head actuator supporting a head slider at a tip end of the head actuator;
an attachment base standing on the enclosure in a vertical direction;
a protrusion extending in a horizontal direction from the attachment base and defining a slant getting closer to the recording disk at a location closer to a center of the recording disk; and
a restriction member located within the enclosure at a location opposed to the slant on the protrusion.

2. The recording disk drive according to claim 1, further comprising:
a first sliding surface defined on the protrusion and extending in the horizontal direction from a highest end of the slant along a surface of the attachment base, said first sliding surface getting opposed to the restriction member; and
a second sliding surface defined on the protrusion and extending downward from the first sliding surface along the surface of the attachment base.

3. The recording disk drive according to claim 2, wherein said second sliding surface is opposed to the restriction member.

4. The recording disk drive according to claim 3, wherein said restriction member is fixed to an inward surface of the enclosure.

5. The recording disk drive according to claim 3, wherein said restriction member is integral to the attachment base and the protrusion based on integral molding.

6. A ramp member for a recording disk drive, comprising:
an attachment base standing in a vertical direction from a lower end received on an enclosure of the recording disk drive;
a protrusion extending in a horizontal direction from a surface of the attachment base and defining a slant getting closer to the recording disk at a location closer to a center of a recording disk; and
a restriction piece defining an opposed surface opposed to the slant on the protrusion.

7. The ramp member according to claim 6, further comprising:
a first sliding surface defined on the protrusion and extending in the horizontal direction from a highest end of the slant along a surface of the attachment base, said first sliding surface getting opposed to the restriction piece; and
a second sliding surface defined on the protrusion and extending downward from the first sliding surface along the surface of the attachment base.

8. The ramp member according to claim 7, wherein said restriction piece is coupled to the attachment base based on integral molding.

9. A ramp member for a recording disk drive, comprising:
an attachment base standing in a vertical direction from a lower end received on an enclosure of the recording disk drive;
a protrusion extending in a horizontal direction from a surface of the attachment base and defining a slant getting closer to the recording disk at a location closer to a center of the recording disk;
a first sliding surface defined on the protrusion and extending in the horizontal direction from a highest end of the slant along a surface of the attachment base;
a second sliding surface defined on the protrusion and extending downward from the first sliding surface along the surface of the attachment base; and
a restriction piece defining an opposed surface opposed to the first sliding surface.

10. The ramp member according to claim 9, wherein said restriction piece is coupled to the attachment base based on integral molding.

11. A housing cover comprising:
an inward surface extending along a datum plane and opposed to a head suspension supporting a head slider at a tip end; and
a displacement restriction surface swelling from the inward surface and opposed to a ramp member designed to receive the tip end of the head suspension.

12. The housing cover according to claim 11, wherein said displacement restriction surface is opposed to a slant defined on the ramp member so as to get closer to a recording disk at a location closer to a center of the recording disk.

13. The housing cover according to claim 12, wherein said displacement restriction surface is opposed to a sliding surface defined on the ramp member continuously from a highest end of the slant, said sliding surface extending in a direction outward from the recording disk.

14. A housing base comprising:
an inward surface extending along a datum plane and opposed to a head suspension supporting a head slider at a tip end; and
a displacement restriction surface swelling from the inward surface, wherein
said displacement restriction surface is opposed to a slant defined on a ramp member, said slant getting closer to a recording disk at a location closer to a center of the recording disk.

15. The housing base according to claim 14, wherein said displacement restriction surface is opposed to a sliding surface defined on the ramp member continuously from a highest end of the slant, said sliding surface extending in a direction outward from the recording disk.
